(19) United States
(12) Patent Application Publication
(10) Pub. No.: US 2004/0101809 A1
(43) Pub. Date: May 27, 2004

(54) Device, method and materials for mobilizing substances into dentinal tubules in root canal treatment

(76) Inventors: Ervin I Weiss, Herzlia (IL); Zvi Fuss, Tel Aviv (IL); Levi-Shaoul Assouline, Kiryat Bialik (IL); Amir Mizrahi, Kfar Saba (IL)

Correspondence Address: Anthony Castorina, G E Ehrlich (1995) Ltd, Suite 207, 2001 Jefferson Davis Highway, Arlington, VA, 22202, US

(21) Appl. No.: 10/380,617

(22) PCT Filed: Sep. 21, 2001
(86) PCT No.: PCT/IL01/00885

(51) Int. Cl. A61C 5/02

(52) U.S. Cl. 433/224; 433/32

(57) ABSTRACT

A device, method and composition of matter for use in mobilizing a medicament into the dentinal wall of a tooth comprising depositing a charged substance within a cavity of a tooth and subjecting the substance to an electric charge.

### FIELD AND BACKGROUND OF THE INVENTION

The present invention relates to the field of dental treatment and, more particularly, to a device and method for mobilizing substances into tooth material.

Anyone who has suffered a root canal procedure can attest to it being one of life's more unpleasant experiences. Root canal treatment is necessary whenever the tissue in a root canal is infected by bacteria. Such bacteria and their products that have invaded the pulp within a root canal can migrate into the surrounding bone, resulting in a greatly exacerbated infection and bone resorption.

Therefore, the purpose of root canal treatment is to terminate the present infection by removing or killing bacteria that are within the root canal and to fill and seal the space in order to prevent reinfection.

In the current state of dentistry, a root canal is disinfected by mechanical debridement of the canal wall and the application of an antiseptic substance within the canal to kill remaining bacteria. FIG. 1 shows a cross section of a tooth in which a root canal is shown in the process of debridement.

The wall surrounding a root canal consists of dentin, a calcified organic matrix through which approximately 30,000 tubules/mm² pass horizontally from the root canal space towards the outer surface of the root. These tubules typically have a diameter of 2-5 micrometers and are not uniform in shape or size throughout the length of the root. In addition, there are other irregular spaces around the root canal space which include isthmuses, ramifications, accessory canals and apical deltas. FIGS. 2 and 3 are schematic illustrations of a cross section of a root of a tooth in which the dentin tubules and additional irregular spaces are shown emanating from the canal and radiating outward toward the outer wall of the root.

The dentinal tubules are also filled with organic matter. Bacteria which have a diameter of 1 micron easily penetrate, survive and even proliferate in these tubular structures as well as in the root canal itself and irregular spaces. Therefore, in order for a root canal treatment to be successful, it is essential to remove or kill the bacteria present throughout the dentinal tubule structure and irregular spaces. The treatment fails when infecting bacteria are not eliminated completely from both the root canal space and the dentinal tubules and irregular spaces.

According to the prior art, dental technology has found it difficult to completely eradicate all bacteria during a root canal treatment procedure. The current technology does not appear to be capable of reliably disinfecting the canal wall in all cases Accordingly, it is now widely accepted that bacteria residing in dentinal tubules and irregular spaces is the primary cause of persistent endodontic infections.

Much has been written about this phenomenon, including a long-term study concluded in 1990 which revealed a 14 percent failure rate of root canal treatment, (Siogren U, Hagglund B, Sundqvist G, Wing K. Factors Effecting the Long-term Results of Endodontic Treatment., J Endod 1990; 16:498-504). The central role of bacteria in the periapical pathologic events was shown in a study which demonstrated that bacteria commonly remain in root canal systems after conventional mechanical preparation, (Kakehashi S, Stanley H R, Fitzgerald R J. The Effect of Surgical Exposures of Dental Pulps in Germ-free and Conventional Laboratory Rats., Oral Surg 1965; 20: 340-9).

It was shown that bacteria which survived mechanical preparation and irrigation during root canal treatment increased rapidly in between treatments, (Bystrom A, Sundqvist G. Bacteriologic Evaluation of the Efficacy of Mechanical Root Canal Instrumentation in Endodontic Therapy., Scand. J. Dent. Res. 1981; 89:321-8.; Bystrom A, Sundqvist G. The Antibacterial Action of Sodium Hypochlorite an EDTA in 60 Cases of Endodontic Therapy., Int Endod J 1985; 18:35-40).

Although a variety of intracanal medicaments are used to eliminate bacteria and to disinfect the root canal walls, in vitro tests showed that bacteria are killed only when they are in direct contact with such medicaments, (Spangberg L S W (1982): Endodontic Medicaments. In: Biocompatibility of Dental Materials, D. C. Smith and D. F. Williams, Eds., Boca Raton: CRC Press, pp. 223-257).

Moreover, it has been shown repeatedly that such medicaments have limited ability to penetrate into and disinfect the dentinal tubules, (Siqueira J F, Uzeda M. Disinfection by Calcium hydroxide Pastes of Dentinal Tubules Infected With Two Obligate and One Faculative Anaerobic Bacteria., J Endodon 1996; 22:674-6.; Haapasalo M, Orstavik D. In Vitro Infection and Disinfections of Dentinal Tubules. J Dent Res 1987; 66:8: 1375-9.)

According to current practice, removal of infected tissue is effected primarily by mechanical debridement of the root canal wall. Remaining living tissue and bacteria are treated by the introduction of an antiseptic material to kill the bacteria. However, it is known that such materials possess limited ability to penetrate the dentinal wall and therefore do not reach all of the remaining bacteria residing therein. Accordingly, many techniques have been tried to comprehensively disinfect a dentinal wall.

U.S. Pat. No. 4,886,075 discloses a thermoelectric antibacterial ion-generating device comprising a needle which fits into the root canal of a tooth undergoing endodontic therapy. A field of positive silver ions is generated in the root apex area for killing bacteria that are in the infected bone area around an abscessed tooth. The treatment disclosed, however, effects only the periodontal membrane and bone surrounding the tooth. There is no disclosed effect on bacteria which invade the dentinal tubules and/or irregular spaces.

Soviet Union Patent No. 1806683 discloses the use of an electrode of a diathermal coagulator which generates electric current resulting in heat. The heat causes a medicament within the root canal to evaporate, allowing the vapors to diffuse into the dentinal tubules. However, such evaporation does not cause sufficient penetration to reach bacteria deep within the dentin tubules. Moreover, the heat generated can cause protein denaturation and thus irreversible damage to soft and hard tissues and weaken the remaining tooth structure.

Russian Patent No. 2008841 discloses a treatment’ which includes applying root canal filling material under vacuum.

Soviet Union Patent No. 1775394A discloses a ferroelectrically active ceramic (piezoelectric) element connected to needle electrodes inserted into the root canal space. The vibration created by the piezoelectric element introduces a medicament into the root canals.

Soviet Union Patent No. 869773E shows the use of a magnetic field as the driving force for introducing a medicament into the root canal space.

There is also known in the art a method of treating a root canal that uses an electric field to disperse an antiseptic. A. Knappwost of the Leodent Export-Import Company of Bremen, Germany, describes a method, which does not include mechanical removal of the infected material but rather relies solely upon a medicament in order to disinfect the unprepared root canals. A discussion of this method may be found in Knappwost A. Das Depotophorese-Verfahren mit Kupfer Calciumhydroid, die zur systematischen ausheilung fihrende alternative in dir endodontie. ZWR der Zahnarzt 1993, 618.

Knappwost's method suffers a number of serious limitations. First, the electrodes are not introduced all the way to the root end (apex) and therefore its effectiveness at the most needed area is limited or questionable. Second, the electrode is not insulated or masked and thus there is no control of the direction of the electric field. Therefore, the current may flow to the least resistive area rather than to the needed one. Third, there is no seal or insulation placed at the apex of the root canal. Therefore, the materials, which are intended to penetrate the canal walls, may flow out through the apex without reaching the dentinal tubules. Fourth, the method requires two to three visits to the dentist rather than one.

There is thus a widely recognized need for, and it would be highly advantageous to have, a device and method of treating a cavity in a tooth that does not suffer the limitations of the prior art and is capable of mobilizing a medicament deeply within the dentinal tubules of a tooth and irregular spaces in the root canal.

### SUMMARY OF THE INVENTION

Accordingly, it is an object of the present invention to provide a method, a device and a composition of matter that mobilize a substance into a cavity of a tooth and achieve deep penetration of the dentinal wall and irregular spaces and, consequently, disinfection of the microorganisms residing therein.

According to one aspect of the present invention there is provided a device for delivering a charged substance into a cavity of a tooth comprising a device body and a pair of electrodes attached thereto, the device being designed and configured so as to enable positioning of at least one electrode within the cavity, thus enabling intra-cavity mobilization of a charged substance placed within an electrical field generated between the pair of electrodes.

According to another aspect of the present invention there is provided a method of mobilizing a charged substance into a cavity of a tooth comprising generating an electric field within the cavity and placing the charged substance within the electric field, thereby mobilizing the charged substance into the cavity.

According to yet another aspect of the present invention there is provided a composition-of-matter comprising an anti-septic agent embedded within a porous material, both being selected such that when the composition of matter is positioned within an electrical field, the anti-septic agent releases out of the porous material in a direction substantially parallel to the electrical field.

According to features in the described preferred embodiments the cavity is a root canal and at least one electrode is designed and configured for placement within the apex region of the root canal.

According to features in the described preferred embodiments at least one electrode is designed and configured such that the electrical field generated is capable of mobilizing the charged substance into adjacent dentinal tubules, lateral canals, isthmuses and/or apical deltas of the root canal.

According to features in the described preferred embodiments the device further comprises a reservoir removably attached to the device body and positioned between the pair of electrodes, the reservoir being for containing the charged substance.

According to features in the described preferred embodiments the reservoir is designed and configured such that when subjected to the electrical field, the charged substance contained therein is released therefrom in a direction parallel to the electrical field.

According to features in the described preferred embodiments the reservoir is composed of a porous material suitable for deposition within a cavity of a tooth.

According to features in the described preferred embodiments the charged substance is selected from the group consisting of an antibacterial substance, an antifungal substance, an antiviral substance, an antiinflamatory substance and a tooth filling substance.

According to features in the described preferred embodiments the charged substance is calcium hydroxide.

According to features in the described preferred embodiments the charged substance is chlorhexidine or any other charged medicament.

According to features in the described preferred embodiments the charged substance serves for treating a disease of said tooth or for tooth repair.

According to features in the described preferred embodiments the reservoir further includes a charging agent for charging the substance prior to or concomitant with its release from the reservoir.

According to features in the described preferred embodiments the device further comprises a power source for generating the electrical field between the pair of electrodes.

According to features in the described preferred embodiments the power source is contained within the device body.

According to features in the described preferred embodiments the method further comprises charging a substance so as to form the charged substance prior to placing the charged substance within the electric field.

According to features in the described preferred embodiments the electrical field is generated by a pair of electrodes, whereas at least one electrode is designed and configured for placement within the cavity.

According to features in the described preferred embodiments the porous material selected is sufficiently pliable so as to enable molding into a cavity formed within a tooth.

### BRIEF DESCRIPTION OF THE DRAWINGS

With specific reference now to the drawings in detail, it is stressed that the particulars shown are by way of example and for the purposes of illustrative discussion of the preferred embodiment of the present invention only, and are presented in the cause of providing what is believed to be the most useful and readily understood description of the principles and conceptual aspects of the invention. In this regard, no attempt is made to show structural details of the invention in more detail that is necessary for a fundamental understanding of the invention, the description taken with the drawings making apparent to those skilled in the art how the several forms of the invention may be embodied in practice.

In the drawings:

FIG. 1 is a sectional view of a tooth undergoing conventional root canal treatment;

FIG. 2 is a schematic illustration of a side view cross section of a root of a tooth;

FIG. 3 is a schematic illustration of a top view cross section of a root of a tooth;

FIG. 4 is a schematic illustration of a device constructed in accordance with the present invention;

FIG. 5 is an illustration of electrodes of the device of FIG. 4;

FIG. 6 is a graph representing the results of an experiment testing the efficacy of the present invention; and

FIG. 7 is a graph representing the results of a second experiment testing the efficacy of the present invention.

### DESCRPTION OF THE PREFERRED EMBODIMENTS

The preferred embodiment of the present invention is of a method and device for disinfecting the root canal of a tooth during a root canal dental procedure. The method and device of the present invention provide advantages over existing methods and devices in that they provide for substantial eradication of microorganisms from within the porous dentin wall of the root canal. The present invention is also useful for applying intracanal medication, obturation of the root canal, tooth restoration and root surface desensitization and sealing.

The most common purpose of root canal treatment is to terminate an infection by removing or killing the active bacteria present within the root canal, including those resident within the dentinal tubules and irregular spaces of the canal wall. Numerous approaches directed at delivering antiseptic materials into the dentinal tubules have been proposed, including generating a field of positive silver ions around the bacteria; using heat to cause a medicament to evaporate, allowing the vapors to diffuse into the dentinal tubules; applying root canal filling material under vacuum; using vibration to introduce a medicament into a root canal; using a magnetic field as the driving force for introducing a medicament into the root canal space; and using a broad electric field to disperse an antiseptic within the root canal. None of the described techniques attempts nor is able to sufficiently penetrate the dentinal wall in order to reach the bacteria residing in the porous structure thereof.

While reducing the present invention to practice, the present inventors have uncovered that a directed and localized electrical field can be used to efficiently deliver charged substances into dentinal tubules and irregular spaces of a tooth.

Thus, the present invention provides a novel and effective method and device which can be used to direct a charged substance, such as an antiseptic material, into the network of spaces within the root canal and dentinal wall thus preventing bacterial colonization therein.

Before explaining at least one embodiment of the invention in detail, it is to be understood that the invention is not limited in this application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

The principles and operation of a method and device for mobilizing a substance into a tooth cavity according to the present invention may be better understood with reference to the drawings and accompanying descriptions.

Thus, according to one aspect of the present invention there is provided a method of mobilizing a charged substance into a cavity of a tooth. As is further detailed hereinafter, the charged substance can be medicament, such as an antibiotic, or a tooth repair material, such as a root canal filler or dentin tubules sealer.

As used herein the phrase “a cavity of a tooth” refers to any hollowed out space within a tooth which is naturally present, such as the canal within the root of a tooth which contains the nerve and other living tissue commonly referred to as the pulp, or a cavity formed as a result of natural decay or a dental procedure.

The method of the present invention is effected by subjecting the charged substance to an electrical field which is generated within the cavity of the tooth as is further described hereinbelow.

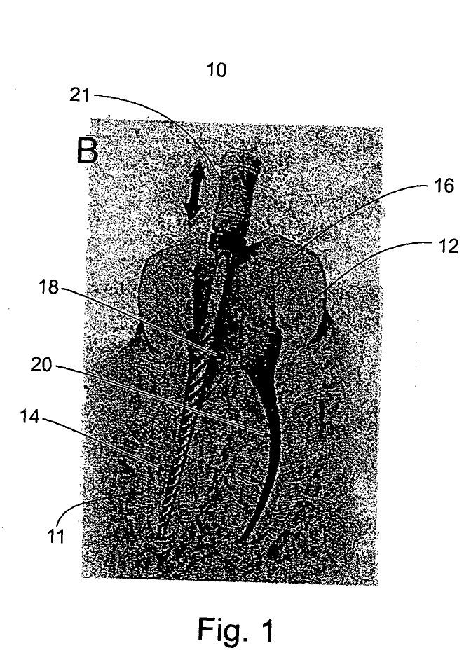

Reference is now made to FIG. 1 which shows a cross section of a tooth, hereinafter tooth 10, depicting the root 11, the enamel outer coating 12, the dentin structure 14, the natural pulp chamber 18, a decay induced or treatment induced cavity in the crown of the tooth extending into pulp chamber 18, hereinafter referred to as cavity 16, and root canal space 20.

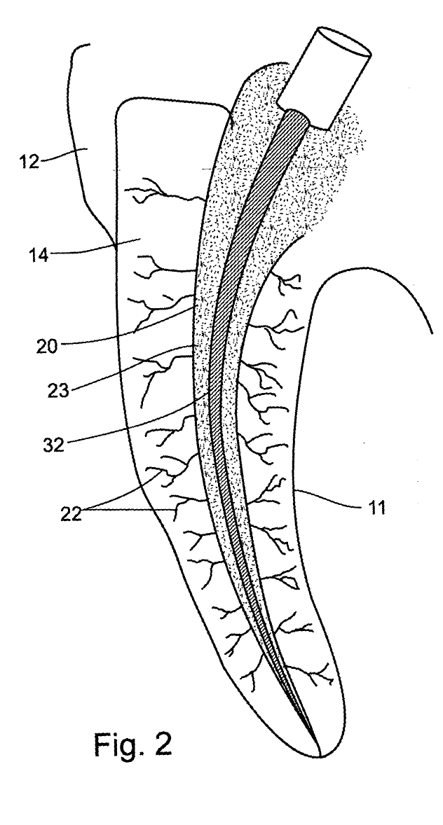

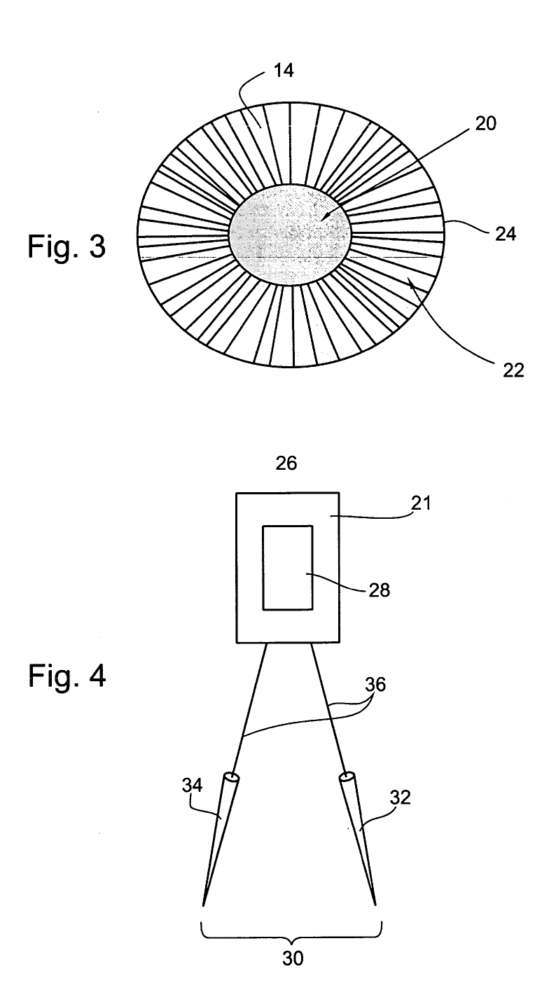

Dentin 14 is a calcified organic matrix through which approximately 30,000 tubules/mm² pass horizontally from the root canal space towards the outer surface of the root. These tubules typically have a diameter of 2-5 micrometers and are not uniform in shape or size; other irregular spaces include isthmuses, ramifications, accessory canals and apical deltas. FIGS. 2 and 3, which also show cross sections of root 11, further depict the structure of dentin 14, showing tubules 22 radiating outwardly from root canal space 20 to outer surface 24 of root 11.

This complex network of canals and tubules enables bacterial colonies to evade prior art treatment methods thus causing the formation of bacterial infections even following anti bacterial treatments. The method of the present invention traverses the shortcoming of prior art approaches by enabling eradication of bacterial colonies even when sequestered within deep canals and tubules.

The method of the present invention is preferably effected using a dedicated device designed and configured for the delivery of charged substances into the cavity.

One configuration of such a device, which is referred to herein as device 26 is shown in FIG. 4.

Device 26 has a body 27 containing therein a power source 28 for generating an electric current to be conducted via connecting wires 36 to a pair of electrodes, referred to jointly as electrodes 30. Power source 28 may be self contained, having disposable or rechargeable batteries, or may be connected to another power source with a transformer to reduce the voltage and amperage to the level required.

Electrodes 30, include electrode 32 which is designed and configured to be placed within root canal space 20, preferably as deep as the root apex, and electrode 34 which is preferably designed and configured to be placed outside of tooth 10 attached to the oral mucosa in proximity to tooth 10. Electrodes 30 serve to define the electric field which is generated therebetween by powersource 28. Electrodes 30 may be made of any electro-conductive material, but are preferably made of metal, conductive silicones and/or polymers; electrodes 30 can be disposable or reusable.

Electrodes 30 are designed and configured such that an electric field generated therebetween is capable of mobilizing the charged substance to a predetermined target area. Accordingly, the intended deployment of each electrode will determine its shape, size and flexibility. Electrodes 30 will be designed and configured to create the required electric field strength, size, shape and direction within root canal space 20.

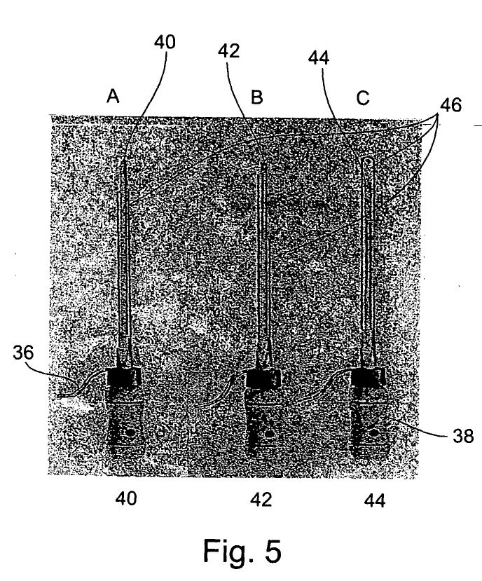

Attention is now drawn to FIG. 5, which shows a detailed depiction of three electrode configurations which can be used with device 26, hereinafter referred to electrodes 40, 42 and 44.

Electrodes 40, 42 and 44 have insulated holders 38 for manipulation by a user, connecting wires 36 for connection to power source 28, and varying configurations of insulation, hereinafter referred to in all of its possible configurations as insulation 46, in order to direct the flow of current and consequently the size, shape and position of the resultant electric field.

Insulation can be obtained by selectively coating the electrodes. Examples of insulating materials include but are not limited to silicon, rubber, gutta percha, wax and Teflon. Selectively coating the electrode with insulating material directs the electrophoretic current to predetermined specific and limited areas along the dentinal wall of root canal space 20 or anywhere within cavity 16 including pulp chamber 18. The uncoated and non-insulated area on the electrode is positioned facing the area that requires treatment. If electrodes 30 are not insulated, the electric current will emanate from their entire exposed conducting surface and will be dispersed broadly. Consequently, the charged substance may not be delivered to the sites in need of treatment because the electric field will be diffused and resistance into the sites of treatment may be greater than the resistance of areas other than the area of treatment. It is appreciated that electrodes 30 may be insulated in any fashion and to any degree appropriate to the treatment indicated. For instance, a small pinpoint of both electrodes 32 and 34 may be left uninsulated and positioned with the pinpoints facing one another in order to treat a small targeted area of tooth 10. Conversely, electrodes 32 and 34 may have their entire distal ends completely uninsulated in order to create a 360 degree electric field to treat the entire root tip in one treatment.

FIG. 5, illustrates various configurations of insulation which expose different parts of the electrode. It is understood that all such configuration are contemplated within the scope of the preferred embodiment.

Reference is now made again to FIG. 2, which shows a cross section of root 11 with electrode 32 of device 26 inserted into root canal space 20. Attention is drawn to the network of outwardly radiating dentinal tubules 22 appearing throughout dentin 14.

The use of a device designed and configured for intra-cavity delivery of substances such as medicaments, substantially increases the efficiency of delivery and penetration of medicaments into dentinal tubules 22 thus substantially increasing the efficiency of treatment.

As clearly shown by the results presented in the Examples section which follows, the use of an intra-tooth electrical field generated according to the teachings of the present invention enables delivery of an antiseptic agent even within deep canals and tubules thus decreasing the likelihood of bacterial infection following root canal treatment.

As is mentioned hereinabove, the substance to be introduced may be a medicament, an antiseptic such as an antibacterial, antiviral or antifungal agent, an anti-inflammatory substance, a tooth restorative or filling material or a sealant. Preferred antiseptic agents include calcium hydroxide and chlorhexidine, which have antibacterial properties. Preferred filling materials include Roth cement, AH26, Ketac Endo, MTA, calcium sulfate or others. It is appreciated that any substance for any dental purpose may be applied by the method described herein, as long as the substance is charged or can be charged.

In cases where the substance is not naturally charged it is preferably combined with a charging agent, or subjected to environmental conditions, such as a specific pH environment, which induces charge formation. Methods of charging molecules are well known in the art and as such no further description is given herein. In any case, it is to be understood that the substance to be delivered may be charged prior to or concomitant with its mobilization.

The charged substance can be delivered using any one of several approaches. For example, the charged substance can form a part of a composition of matter, which also includes a non conductive porous material which is suitable for deposition within a cavity of a tooth. The porous material can be a gel, resin or a paste composed of a polymeric material, which is sufficiently pliable so as to be moldable into cavity 16 or root canal space 20.

The mixed porous material charged substance can be molded into a cavity and subjected to an electrical field. This electric field serves to release the charged substance from the composition of matter and to mobilize the molecules of the charged substance into dentin 14 such that they penetrate into the tubule network therein.

The composition of matter can also be molded into disposable cartridges suitable for use with device 26 described hereinabove

The charged substance can also be provided as a liquid preparation, which can be placed within the cavity or within a reservoir utilized by device 26 described hereinabove. Such a reservoir is designed and configured so as to enable release of the charged substance when subjected to an electrical field.

The following illustrates the use of device 26 illustrated in FIG. 4 for disinfecting the bottom centimeter of root 11.

For treating such a limited area effectively, electrode 32 is preferably shaped as a thin flexible cylindrical rod of a size suitable for insertion into root canal space 20, insulated such that only one half of the distal one centimeter is exposed while electrode 34 is shaped to contact the lower lip or directly contact the mucosal surface adjacent to the area of the root apex of the treated tooth. Electrode 34 is preferably insulated such that only the one side of the distal one centimeter is exposed and attached to the mucosal surface. Electrodes 30 will be positioned with electrode 32 within the apex of root canal space 20 and electrode 34 positioned outside of tooth 10 in close proximity thereto but without touching tooth 10. Such a configuration and positioning would allow electrodes 30 to generate an electric field limited in size and shape to the bottom centimeter of root 11, the area located between the two uninsulated segments of electrodes 30.

It is understood that there will be variations in the treatment required by a wide range of dental patients. Therefore, electrodes 30 may be placed in any configuration that will cause the electric field produced to drive the charged substance into the targeted treatment area. Accordingly, the present invention contemplates all such configurations, including variations in the number of electrodes employed and the placement thereof.

It is further understood that the placement of electrodes 30 will be influenced by many factors including the facet of the tooth to be treated, the shape of the mouth, the teeth or other structures intervening between the placement alternatives, and similar structural considerations. Accordingly, a wide range of placement alternatives is required to provide for all treatment contingencies. The preferred range between electrodes 30 is from 1 mm or less to 9 cm or more. A more preferred range is from about 1 mm to about 5 cm. A most preferred range is from about 1 mm to about 2 cm. As used herein, the term “about” refers to ±10%.

In order to treat the identified area, it is necessary to introduce the appropriate charged substance (e.g. antiseptic agent) into root canal space 20 and to position the substance between electrodes 30 at the location of their respective uninsulated segments.

The use of a composition-of-matter, which is sufficiently pliable to be molded to fit into the root canal space requiring treatment is particularly advantageous in this case. It is understood that it is of no importance to the procedure which of electrode 32 or the composition is introduced into root canal space 20 first. In some cases it will be easier to introduce the composition and to thereafter insert electrode 32 into the composition; in other cases it will be preferable to carefully place electrode 32 with visual guidance and thereafter pack the composition around it. Alternatively, the composition can be deposited on electrode 32 prior to insertion so as to enable simulataneous introduction of both into the cavity.

Power source 28 would then generate the appropriate current which is conducted to electrodes 30 to thereby generate the electrical field therebetween.. The charged substance within the composition, which is deposited between electrodes 30, would be subjected to this electric field and would be attracted to or repelled by electrode 32 and electrode 34 as appropriate to their charge. For example, if the charged substance is calcium hydroxide, electrode 32 would be configured as the cathode. Accordingly, the molecules of calcium hydroxide would seek the path of least resistance through the dentinal wall of root canal space 20 interposed between electrode 32 and electrode 34 and would be mobilized into the network of tubules radiating from the inside of root canal space 20 outwardly to outer surface 24 of tooth 10 in an effort to reach electrode 34. When the electric current terminates, the molecules of calcium hydroxide would be left where they were, positioned within the tubular structure of the dentinal wall, in contact with the bacteria residing there.

It is understood that the mobilization of ions causes heat due to the movement of the ions and that the greater the mobilization, the greater will be the heat buildup at the site of the mobilization. As such, the current used for treatment should be controlled such that the temperature of the tooth does not exceed 40° C.

Accordingly, it is a feature of the invention to be able to vary the strength of the electrical filed generated. This is necessary in order to accommodate variations in the treatment indicated. For example, the required treatment may be to a very thin dentinal wall and therefore the electrical field generated may be relatively weak both because deep penetration is not needed and further in order to prevent undue heat buildup which could damage tooth structure and tissue. It is also a feature to be able to vary the duration of field application and to use a pulsing current instead of a continuous one in order to dissipate heat during the treatment. A number of factors will be considered when determining the strength and duration of the filed employed, including but not limited to the size of the treatment area, the molecular size and structure of the charged substance to be mobilized and the thickness and density of the dentin wall to be penetrated.

The strength of the electric field, and thus the strength of the mobilization of the charged substance, is also dependent upon the placement and configuration of electrodes 30. This factor must also be taken into consideration when determining the appropriate charge to use in order to provide appropriate mobilization of material as well as to avoid excessive heat buildup.

For example, a larger area of exposed electrode will produce a broader electric field. Therefore, the energy within the field will be diffused and the movement of ions at any given place within the field will be less than if the field were more constricted and the energy more concentrated. The heat produced will be equally diffused.

The distance separating electrodes 30 will also influence the strength of the field. The farther the distance between electrodes 30, the weaker the repulsion/attraction of charged ions and the smaller the heat buildup. It is understood that the present invention contemplates all appropriate sizes and configurations of electrodes and the placement therebetween of all appropriate distances.

The present invention has a number of preferred uses in addition to the delivery of antiseptic substances. The invention may be used for a traumatic restorative treatment, with the restorative materials driven into the dentinal tubules to improve both retention and seal. The invention can be used for treating root surface sensitivity. Root surface sensitivity occurs when the gum recedes leaving the root exposed. Previously, the treatment involved superficially covering of the surface with a high salt content sealer or with resin based sealer. The primary problem associated with this is that the seal is superficial and can be accidentally removed by tooth brushing. However, using the present invention, the sealer product can be forced deeply into the tubules, providing a long lasting and tight seal.

A further use is with regard to dental and orthopedic implants. Previously, when an implant site became infected, the only solution was to remove the implant, clean the site and reimplant the appliance. By utilizing the present invention, an antibacterial compound may be mobilized into the biofilm of the implant. Natural healing will then occur. After healing has occurred, additional therapeutic compounds may be mobilized, thus providing a preventive treatment to avoid future implant failure.

The present invention has been shown to be effective in mobilizing antiseptic substance into the tubular structures of the dentinal in order to kill bacteria. Such effectiveness has been conclusively demonstrated in two studies undertaken which are set forth hereinafter within the “Examples” section which follows.

The present invention provides a number of advantage over the prior art, as follows:

1. The invention kills bacteria from root canal areas, such as dentinal tubules, ramifications, isthmuses, and apical deltas which are inaccessible to mechanical and conventional chemical preparations;

2. The treatment is short, safe, non-invasive and does not use toxic elements;

3. The invention conforms to the concept of conservative treatment because it requires minimal removal of tooth substance, as opposed to conventional treatments which require removal of dentin substance from the root canal wall in order to eliminate invading bacteria; which in turn may compromise the resistance of the tooth to cracks and breakage;

4. The invention allows the successful completion of root canal treatment in a single visit to the dentist;

5. Using the present invention, sealing materials may be driven into the tubules of the dentinal wall, thus minimizing coronal to apical leakage within the root canal space and providing a barrier against bacterial reinvasion; and

6. The invention also has potential use in treating bacterial-biofilm infecting orthopedic artificial implants.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Additional objects, advantages, and novel features of the present invention will become apparent to one ordinarily skilled in the art upon examination of the following examples, which are not intended to be limiting. Additionally, each of the various embodiments and aspects of the present invention as delineated hereinabove and as claimed in the claims section below finds experimental support in the following examples.

### EXAMPLES

Reference is now made to the following examples, which together with the above descriptions, illustrate the invention in a non limiting fashion. Generally, the nomenclature used herein and the procedures utilized in the present invention include techniques and methods of inducing bacterial cell growth and for inducing bacterial cell death. Such techniques are thoroughly explained in prior art literature and as such are well known to one of ordinary skill in the art.

### Example 1

The following example serves as a testing model for determining the efficacy of three different disinfectant procedures, all using the same antiseptic agent.

The in vitro model for dentinal tubule infection of root canals originally described by Haapasalo and Orstavik (1987) was used in the present invention with some modifications. Extracted, intact bovine incisors were kept in 0.5% NaOCl overnight for surface disinfection. Five millimeters of the apical end and two-thirds of the crown were removed with a rotary diamond saw at 1000 rpm (Isomet plus precision saw, Buehler, Ill. U.S.A.) under cooling water. The root canal of the center piece was enlarged to 2 mm in diameter with a reamer bur (Zipperer, Munich Germany). The cementum was removed using a polish paper (Ecomet 3, variable speed grinder-polisher, Buehler Ill. U.S.A.) under cooling water, resulting in a center-holed root dentin piece of approximately 6 mm outer diameter. The root was then cut into slices of 4 mm thickness with a diamond saw as above. The canals of the 4 mm blocks were enlarged with an ISO 023 round bur using a slow speed dental contrangle handpiece. All teeth and dentin slices were kept in vials containing tap water during all procedures to avoid dehydration. Sterilization was conducted by autoclaving the specimens in the vials for 15 minutes at 121° C. Six specimens serving as negative control were incubated in growth media at 37° C. for 48 hours to confirm sterilization.

A total of 24 sterile specimens were divided to four groups. Each of the 24 specimens were transferred to separate test tubes containing 1.5 ml brain heart infusion broth 37 g/liter H₂O (Difco, Detroit, Mich., U.S.A.) inoculated with the test microorganism. This medium was changed every two days for 21 days.

Enterococcus faecalis, a common isolate from infected root canals (Sundqvist 1992) was used in numerous studies of antibacterial properties because of its relative resistance (Haapasalo & Orstavik 1987). In the present invention, a clinical isolate of E. faecalis T2, which was selected to be resistant to 2 mg ml-1 streptomycin (Weiss et al 1996, Shalhav et al 1997, Fuss et al 1997), was used. Streptomycin sulfate, at a concentration of 0.5 mg/ml, was included in all test tubes including the controls to overcome possible contamination in the experimental setup (Weiss et al. 1996). Calcium hydroxide [Ca(OH)₂] in an aqueous paste was introduced into the root canal space of the experimental specimens. In groups 1 and 2 (6 specimens/group), ions derived from Ca(OH)₂ were mobilized via a low current electric field created using an electrode which was inserted into the root canal space while another electrode was positioned outside the specimen. Group 1 received a current of 5 miliamperes per 5 minutes while Group 2 received two sets of similar current. In Group 3 the Ca(OH)₂ was left for a week without receiving any current. Group 4 served as control without Ca(OH)₂.

At the end of the experiment period, dentinal samples were taken from each test specimen with sterile round burs mounted in a handpiece and run at low speed. The specimens were kept in place with sterile forceps during the sampling and the burs were used in sequence in the following ISO sizes: 025, 027, 029 and 031. Prior to sampling, the coronal and apical surfaces of each specimen were gently curreted to prevent possible remnants of bacteria. Each bur removed a dentinal layer from the inner surface of the canal in the shape of a hollow cylinder 100 μm thick with increasing radius as burs were changed. The dentin chips obtained with each bur were immediately collected in separate test tubes containing 1 ml of brain heart infusion broth and streptomycin. The tubes were vigorously mixed by vortex and incubated for one hour at 37° C. with agitation. Thereafter, the content of each test tube was serially diluted (10×) and triplicate samples of 0.01 ml were spread on brain heart infusion agar plates. These plates were incubated for 24-48 hours at 37° C. Growing colonies were counted and recorded as colony forming units (cfu). For each dentinal layer at least triplicate samples from two agar plates were counted.

The cfu represents a close estimate of viable bacteria penetrated into dentinal tubules at different layer depths. The numbers of cfu obtained from 4 consecutive dentinal layers are presented in FIG. 5. As can be seen in the graph presented, in the control specimens heavy bacterial infection was observed at the layer close to the lumen. This decreased rapidly from layer to layer up to the deepest layer tested (400 μm) which contained several hundred cfu. Treatment with Ca(OH)₂, without electric current, reduced the amount of viable bacteria in the first and second layers, but did not eliminate them completely. However, in the third and fourth layers, Ca(OH)₂ had no effect on bacterial viability.

The application of low electric current using the method and the device of the present invention completely eliminated bacterial survival in the dentinal tubules at least up to 400 μm from the root canal lumen. Therefore, this example conclusively illustrates that bacteria can be affected and even effectively killed at a distance of more than 400 μm from the dentin surface by using the method of the present invention.

### Example 2

The following example serves as a testing model to determine the efficacy of hydroxyl diffusion into a dentinal wall when subjected to a low current electrical charge. Hydroxyl ions diffusion can be determined by measuring the pH of dentin at the outer root surface. (A. Nerwich, et al 1993).

Twelve extracted human permanent teeth with single canals were divided in two groups; experimental and control. Teeth were stored in unbuffered saline solution containing 0.05% sodium azide until used. All root canals were cleaned and shaped to a size 40 master file 1 mm from the anatomical apex. Irrigation during cleaning and shaping was carried out with 2.5% NaOCl. The canals were flushed with 1 ml of 17% EDTA which was left in place for one minute to remove the smear layer followed by a final irrigation with 5 ml of sodium hypochlorite. Cavities were drilled in the outer root surfaces of all teeth at midway between the cement enamel junction and the root apex. The cavities, 1.75 mm diameter, were cut to an approximate depth of 1.0 mm from the root canal space. Root canal spaces of all teeth were filled by injecting an aqueous suspension of calcium hydroxide [Ca(OH)₂] at a pH of 12.5.

In six teeth, OH⁻ ions were mobilized via a low current electric field, created using an electrode inserted in the root canal space and another electrode located outside the specimen, both conducting a 10 miliamperes current for five minutes. The other six teeth served as control without electric current. The pH in the cavities drilled in the dentin was determined using a pH microelectrode (model MI 4152. Microelectrodes Inc., Londonderry, N.H.). The pH measurements were performed within two minutes after the current application.

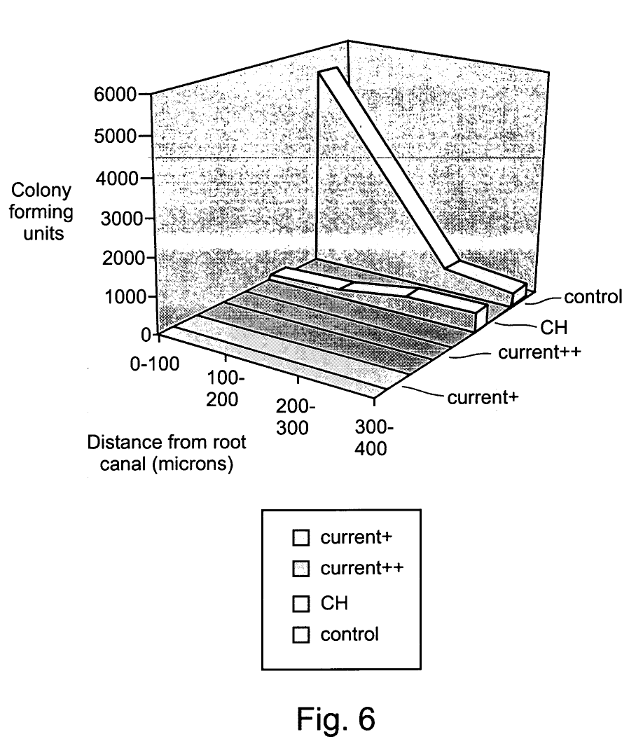

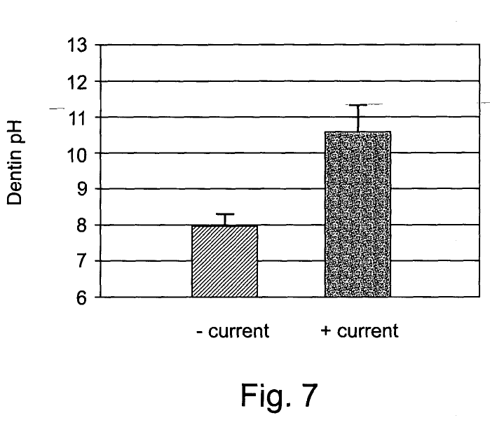

Results are shown in FIG. 6. In the control group, the average pH value of the root dentin measured at a depth of approximately 1 mm from the root canal space was 8.0. This pH value is in agreement with the results of Nerwich, et al. (1993). However, in the experimental group subjected to electric currents a significantly higher pH was measured; an average of 10.6 pH.

This experiment demonstrates conclusively the enhanced penetration of ions achieved by subjecting the charged substance to a mild electric current, as disclosed by the present invention.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents, and patent applications mentioned in this specification are herein incorporated in their entirety by reference into the specification, to the same extent as if each individual publication, patent, or patent application was specifically and individually indicated to be incorporated herein by reference. In addition, citation or identification of any reference in this application shall not be construed as an admission that such reference is available as prior art to the present invention.

### References Cited

Akpata E S, Blechman H. Bacterial Invasion Of Pulpal Dentin Wall In Vitro. J Dent Res 1982;61:435-8

Bystrom A, Sundqvist G. Bacteriologic Evaluation Of The Efficacy Of Mechanical Root Canal Instrumentation In Endodontic Therapy. Scand. J. Dent. Res. 1981;89:321-8.

Bystrom A, Sundqvist G. The Antibacterial Action Of Sodium Hypochlorite An EDTA In 60 Cases Of Endodontic Therapy. Int Endod J 1985;18:35-40.

Bystrom A, Sundqvist G. Bacteriologic Evaluation Of The Effect 0.5 Per Cent Sodium Hypochlorite In Endodontic Therapy. Oral Surg 1983;55:307-312.

Fuss Z, Weiss El, Shalhav M. Antibacterial Activity Of Calcium Hydroxide-Containing Endodontic Sealers On Enterococcus Faecalis In Vitro. Int Endod J. 1997;30:397-402.

Gutmann J L. Adaptation Of Injected Thermoplasticized Gutta-Percha In The Absence Of The Dentinal Smear Layer. Int Endod J 1993;26:87-92.

Gutmann J L. Clinical, Radiographic And Histologic Perspectives On Success And Failure In Endodontics. Dental Clinics of North America 1992;36:379-93.

Haapasalo M, Orstavik D. In Vitro Infection And Disinfections Of Dentinal Tubules. J Dent Res 1987; 66:8: 1375-9.

Kakehashi S, Stanley H R, Fitzgerald R J. The Effect Of Surgical Exposures Of Dental Pulps In Germ-Free And Conventional Laboratory Rats. Oral Surg 1965;20: 340-9.

Knappwost A. Das Depotophorese-Verfahren mit Kupfer-Calciumhydroid, Die Zur Systematischen Ausheilung Fuhrende Alternative In Dir Endodontie. ZWR der Zahnarzt 1993, 618.

Nerwich A., Figdor D., Endo D., and Messer H. H., pH Changes In Root Dentin Over A Four Week Period Following Root Canal Dressing With Calcium Hydroxide. Journal of Endodontics 1993. 19:302-306.

Saunders W P, Saunders E M. Coronal Leakage As A Cause Of Failure In Root-Canal Therapy: a review. Endod Dent Traumatol 1994;10:105-8.

Shalhav M, Fuss Z, Weiss I E. In Vitro Antibacterial Activity Of A Glass lonomer Endodontic Sealer. J. Endodon 1997;23:616-619.

Siqueira J F, Uzeda M. Disinfection By Calcium Hydroxide Pastes Of Dentinal Tubules Infected With Two Obligate And One Faculative Anaerobic Bacteria. J Endodon 1996;22:674-6

Sjogren U, Hagglund B, Sundqvist G, Wing K. Factors Affecting The Long-Term Results Of Endodontic Treatment. J Endod 1990; 16:498-504.

Spangberg LSW (1982): Endodontic medicaments. In: Biocompatibility of Dental Materials, D. C. Smith and D. F. Williams, Eds., Boca Raton: CRC Press, pp. 223-257.

Sundqvist G K. Ecology Of The Root Canal Flora. J Endodon 1992; 18:427-430.

Swanson K, Madison S An Evaluation Of Coronal Microleakage In Endodontically Treated Teeth. Part I. Time periods. J. Endod 1987;13:56-9.

van Amerongen W E, Rahimtoola S. Is ART Really A traumatic? Community Dent Oral Epidemiol 1999;27:431-435.

Weiss E, Shalhav M, Fuss Z. Assessment Of Antibacterial Activity Of Endodontic Sealers By A Direct Contact Test. Endod Dent Traumatol 1996;12:179-184.

What is claimed is:

1. A device for delivering a charged substance into a cavity of a tooth, the device comprising a device body and a pair of electrodes attached thereto, the device being designed and configured so as to enable positioning of at least one electrode of said pair of electrodes within said cavity, thus enabling intra-cavity mobilization of a charged substance placed within an electrical field generated between said pair of electrodes.

2. The device of claim 1, wherein said cavity is a root canal and said at least one electrode of said pair of electrodes is designed and configured for placement within the apex region of said root canal.

3. The device of claim 2, wherein said at least one electrode of said pair of electrodes is designed and configured such that said electrical field generated is capable of mobilizing said charged substance into adjacent dentinal tubules, lateral canals, isthmuses and/or apical deltas of said root canal.

4. The device of claim 1, further comprising a reservoir being removably attached to said device body and positioned between said pair of electrodes, said reservoir being for containing said charged substance.

5. The device of claim 4, wherein said reservoir is designed and configured such that when subjected to said electrical field, said charged substance contained therein is released therefrom in a direction parallel to said electrical field.

6. The device of claim 4, wherein said reservoir is composed of a porous material.

7. The device of claim 1, wherein said charged substance is selected from the group consisting of an antibacterial substance, an antifungal substance, an antiviral substance, an antiinflamatory substance and a tooth filling substance.

8. The device of claim 7, wherein said charged substance is calcium hydroxide or chlorhexidine.

9. The device of claim 4, wherein said charged substance serves for treating a disease of said tooth.

10. The device of claim 4, wherein said charged substance is used for tooth repair.

11. The device of claim 4, wherein said reservoir further includes a charging agent, said charging agent being for charging said substance prior to or concomitant with its release from said reservoir.

12. The device of claim 1, further comprising a power source being for generating said electrical field between said pair of electrodes.

13. The device of claim 12, wherein said power source is contained within said device body.

14. A method of mobilizing a charged substance into a cavity of a tooth, the method comprising,
(a) generating an electric field within the cavity; and
(b) placing the charged substance within said electric field, thereby mobilizing the charged substance into said cavity.

15. The method of claim 14, further comprising charging a substance so as to form said charged substance prior to step (b).

16. The method of claim 14, wherein said electrical field is generated by a pair of electrodes, whereas at least one electrode of said pair of electrodes is designed and configured for placement within the cavity.

17. The method of claim 16, wherein said cavity is a root canal and whereas said at least one electrode of said pair of electrodes is designed and configured for placement within the apex region of said root canal.

18. The method of claim 16, wherein said at least one electrode of said pair of electrodes is designed and configured such that said electrical field generated is capable of mobilizing said charged substance into adjacent dentinal tubules, lateral canals, isthmuses and/or apical deltas of said root canal.

19. The method of claim 14, wherein said charged substance is selected from the group consisting of an antibacterial substance, an antifungal substance, an antiviral substance, an antiinflamatory substance and a tooth filling substance.

20. The method of claim 14, wherein said charged substance is calcium hydroxide or chlohexidine.

21. The method of claim 14, wherein said charged substance serves for treating a disease of said tooth.

22. The method of claim 14, wherein said charged substance is used for tooth repair.

23. A composition-of-matter comprising an anti-septic agent embedded within a porous material, said antiseptic agent and said porous material being selected such that when the composition of matter is positioned within an electrical field, said anti-septic agent releases out of said porous material in a direction substantially parallel to said electrical field.

24. The composition of matter of claim 23, wherein said porous material is a nonconductive material suitable for deposition within a cavity of a tooth.

25. The composition of matter of claim 24, wherein said cavity is a root canal.

26. The composition of matter of claim 23, wherein said antiseptic agent is selected from the group consisting of an antibiotic substance, an antifungal substance and an antiviral substance.

27. The composition of matter of claim 23, wherein said substance is calcium hydroxide or chlohexidine.

28. The composition of matter of claim 23, wherein said porous material selected is sufficiently pliable so as to enable molding into a cavity formed within a tooth.
